(19) United States
(12) Patent Application Publication
(10) Pub. No.: US 2005/0078567 A1
(43) Pub. Date: Apr. 14, 2005

(54) Method of adaptively controlling sled home-in mode and disc drive using the same

(75) Inventor: Sun-ok Jang, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/903,484

(22) Filed: Aug. 2, 2004

(30) Foreign Application Priority Data
Aug. 5, 2003 (KR) 2003-54219

(51) Int. Cl. G11B 7/085

(52) U.S. Cl. 369/30.1

(57) ABSTRACT

A method of adaptively controlling a sled home-in mode and a disc drive system using the same wherein the method includes determining whether the disc drive entered a system initialize mode; when the disc drive entered the system initialize mode, reading flag information that indicates a position of a pick-up over a disc; and moving the pick-up from the position corresponding to the flag information to a reference position.

### CROSS-REFERENCE TO RELATED APPLICATION

This application claims the priority of Korean Patent Application No. 2003-54219, filed on Aug. 5, 2003, in the Korean Intellectual Property Office, the disclosure of which is incorporated herein by reference.

### BACKGROUND OF THE INVENTION

1. Field of the Invention

The invention relates to a method of and an apparatus for controlling a disc drive, and more particularly, to a method of adaptively controlling a sled home-in mode, in which a pick-up is moved to a reference position on a disc in accordance with a position of the pick-up in an initialize mode of a disc drive, and a disc drive using the same.

2. Description of the Related Art

When a disc drive system is initialized, a disc drive performs a sled home-in mode in which the disc drive moves a pick-up to a reference position in a readable area of a disc.

A conventional sled home-in mode is performed according to the flowchart shown in FIG. 1.

First, it is determined whether a sled home-in command has been generated in a disc drive in operation 110. The sled home-in command is usually generated when a tray open/close mode or power on/off mode, etc., is selected.

When the sled home-in command has been generated, a sled motor is driven inwardly to a center of a disc to move a pick-up to an innermost circumference of the disc in operation 120. The sled motor is then driven outwardly from the center of the disc to move the pick-up to a reference position on the disc in operation 130.

When a mode to perform a system initialize operation is selected, such as a tray open/close mode, while the sled home-in mode is being performed, the above procedure is repeated regardless of a current position of the pick-up. Generally, it takes approximately 2 to 3 seconds to move the pick-up from the innermost circumference to an outermost circumference of the disc, depending on the disc drive type, and therefore it takes at least approximately 2 to 3 seconds to perform the sled home-in mode.

Accordingly, when repeatedly performing the initialize operation, such as when the tray open/close mode is performed without the pick-up being moved, the sled home-in mode is repeatedly performed from the beginning, and therefore it takes a relatively long time until a normal reproduction or recording of the disc is performed.

### SUMMARY OF THE INVENTION

The invention provides a method of adaptively controlling a sled home-in mode and, a disc drive using the same.

According to an aspect of the invention, there is provided a method of adaptively controlling a sled home-in mode in a disc drive, the method including, determining whether the disc drive entered a system initialize mode; when the disc drive entered the system initialise mode, reading flag information that indicates a position of a pick-up over a disc; and moving the pick-up from the position corresponding to the flag information to a reference position.

The system initialize mode may include a condition to perform a tray open/close mode.

The flag information may be set depending on a position of the pick-up to a first state information, when the pick-up is positioned on an innermost circumference of the disc, to a second state information, when the pick-up is positioned in the reference position of the disc after the completion of the sled home-in mode, and to a third state information, when the pick-up is positioned neither on the innermost circumference nor in the reference position of the disc.

The moving the pick-up to a reference position on the disc includes: when the flag information indicates that the pick-up is positioned on the innermost circumference of the disc, driving a sled motor toward the outer circumference of the disc to move the pick-up to the reference position of the disc; when the flag information indicates that the pick-up is positioned in the reference position of the disc, stopping the sled home-in mode; and when the flag information indicates that the pick-up is positioned neither on the innermost circumference nor in the reference position of the disc, driving the sled motor toward the inner circumference of the disc to move the pick-up to the innermost circumference of the disc and then driving the sled motor toward the outer circumference of the disc to move the pick-up to the reference position of the disc.

According to another aspect of the invention, there is provided a disc drive for adaptively controlling a sled home-in mode, including: a pick-up that has a laser diode, photo diodes, and various lenses, records signals on a disc and/or detects optical signals reflected from the disc, and converts the optical signals into electrical signals; a sled motor which moves the pick-up in a horizontal direction of the disc; a system controller that sets information in a flag register, according to a position of the pick-up over the disc, reads the information in the flag register when the disc drive is in a system initialize mode, and generates sled motor control signals to move the pick-up from a position that corresponds to the information in the flag register to a reference position of the disc; a servo controller that generates sled motor driving voltages that correspond to the sled motor control signals; and a driving unit that generates driving currents to drive the sled motor, the driving currents corresponding to the sled motor driving voltages.

The system initialize mode may include a condition to perform a tray open/close mode.

The information in the flag register may be set to a first state information, when the pick-up is positioned on the innermost circumference of the disc, to a second state information, when the pick-up is positioned in a reference position of the disc after the completion of the sled home-in mode, and to a third state information, when the pick-up is positioned neither on the innermost circumference nor in the reference position of the disc.

The system controller may drive the sled motor toward the outer circumference of the disc to move the pick-up to the reference position of the disc motor when the information in the flag register indicates that the pick-up is positioned on the innermost circumference of the disc, stop the sled home-in mode when the information in the flag register indicates that the pick-up is positioned in the reference position of the disc, and drive the sled motor toward the inner circumference of the disc to move the pick-up to the innermost circumference of the disc and then drive the sled motor toward the outer circumference of the disc to move the pick-up to the reference position of the disc, when the information indicates that the pick-up is positioned neither on the innermost circumference nor in the reference position of the disc.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become more apparent and more readily appreciated from the following description of the embodiments with reference to the attached drawings in which:

FIG. 1 is a flowchart of a conventional method of controlling a sled home-in mode;

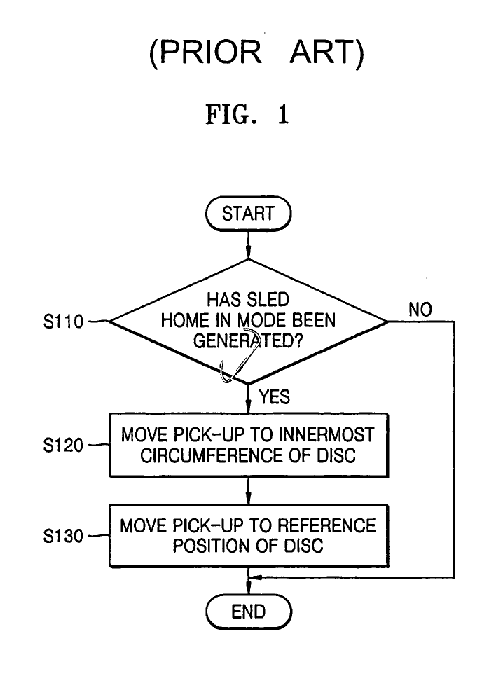

FIG. 2 is a schematic diagram of a disc drive for adaptively controlling a sled home-in mode according to the an embodiment of the invention; and

FIG. 3 is a flowchart of a method of adaptively controlling a sled home-in mode according to an embodiment of the invention.

### DETAILED DESCRIPTION OF THE PREFERRED EMBODIMENTS

Reference will now be made in detail to the embodiments of the invention, examples of which are illustrated in the accompanying drawings, wherein like reference numerals refer to the like elements throughout. The embodiments are described below to explain the invention by referring to the figures.

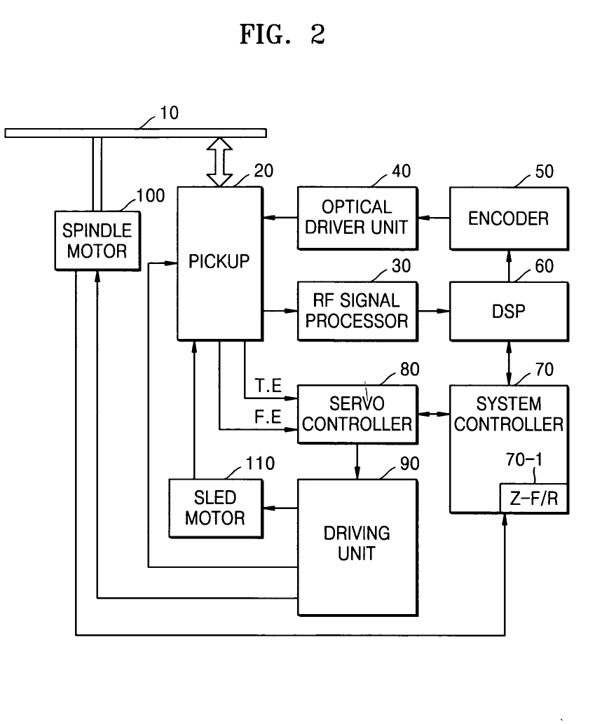

FIG. 2 is a schematic diagram of a disc drive for adaptively controlling a sled home-in mode according to an aspect of the invention. The disc drive includes a disc 10, a pick-up 20, a radio frequency (RF) signal processor 30, an optical driving unit 40, an encoder 50, a digital signal processor (DSP) 60, a system controller 70, a servo controller 80, a driving unit 90, a spindle motor 100, and a sled motor 110. Operations of components of the disc drive of FIG. 2 are described below.

The pick-up 20 includes a laser diode, a plurality of photo diodes, various types of lenses, and an actuator to move the lenses in a vertical/horizontal direction, all of which are not shown. The pick-up 20 projects optical signals on the disc 10, detects optical signals reflected from the disc 10, and converts the detected optical signals into electrical signals. In the pick-up 20, the plural photo diodes are combined to generate a tracking error signal (TE) and a focus error signal (FE) for a servo control, and other signals used for signal processing.

The RF signal processor 30 filters and/or equalizes the signals used for signal processing detected by the pick-up 20, and converts the signals into binary signals to be output to the digital signal processor 60.

The optical driving unit 40 outputs optical driving signals corresponding to input signals in a recording mode, and outputs driving signals to generate predetermined levels of laser power in a reproduction mode.

The encoder 50 reconverts data into bit streams, which has been once converted into the recording format by the digital processor 60, and outputs the reconverted data to the optical driving unit 40.

The digital signal processor 60 performs signal processing to restore the binary signals received from the RF signal processor 30 into the original data, using an inside phase locked clock during the reproduction mode, and to add error correction codes to incoming digital data to be converted into the recording format during the recording mode.

The servo controller 80 uses the tracking error signal and the focus error signal to generate an actuator driving voltage to control an optical lens of the pick-up 20 to move in the horizontal/vertical direction. The servo controller 80 also generates sled motor 110 driving voltages to move the pick-up 30 to a target track during a seek mode. In addition, the servo controller 80 generates a sled motor driving voltage that corresponds to a sled motor control signal generated by the system controller 70, and generates a spindle motor driving voltage to drive the spindle motor 100, corresponding to a target rotation speed of the spindle motor set by the system controller 70.

The driving unit 90 generates driving currents to drive the spindle motor 100 and the sled motor 110 in response to the driving voltages generated by the servo controller 80, and generates actuator driving currents to control the focusing and tracking of the optical lenses of the pick-up 20.

The system controller 70 controls the disc drive. Especially, the system controller 70 contains a flag register (Z-F/R) 70-1 to indicate a position of the pick-up 20. The system controller 70 sets information in the flag register 70-1 depending on positions of the pick-up 20. When the disc drive system enters a system initialize mode, the system controller 70 reads the information in the flag register 70-1 to generate a sled motor control signal to move the pick-up 20 to a reference position of the disc 10 from a base position that corresponds to information in the flag register 70-1.

The system initialize mode includes various conditions for performing a power on/off mode, a tray open/close mode, etc.

The information in the flag register, for example, is set to a first state information Z=1 when the pick-up 20 is positioned on the innermost circumference of the disc, to a second state information Z=2 when the pick-up 20 is positioned in a reference position of the disc 10 after completing the sled home-in mode, and to a third state information Z=0 when the pick-up 20 is positioned neither on the innermost circumference nor in the reference position.

With at least the above set conditions, the system controller 70 performs a control function as described below, according to the information stored in the flag register 70-1 (hereinafter, flag information).

When the flag information Z is 1, indicating that the pick-up is positioned on the innermost circumference of the disc 10, the system controller 70 generates a motor control signal to drive the sled motor 110 toward the outer circumference of the disc 10 to move the pick-up 20 to the reference position of the disc 10. When the flag information Z is 2, indicating that the pick-up 20 is positioned in the reference position of the disc 10, the system controller 70 stops the sled home-in mode. When the flag information Z is 0, indicating that the pick-up 20 is positioned neither on the innermost circumference nor in the reference position of the disc 10, the system controller 70 generates sled motor control signals to drive the sled motor 110 toward the inner circumference of the disc 10 to move the pick-up 20 to the innermost circumference of the disc 10, and then to drive the sled motor 110 toward the outer circumference of the disc 10 to move the pick-up 20 to the reference position of the disc 10.

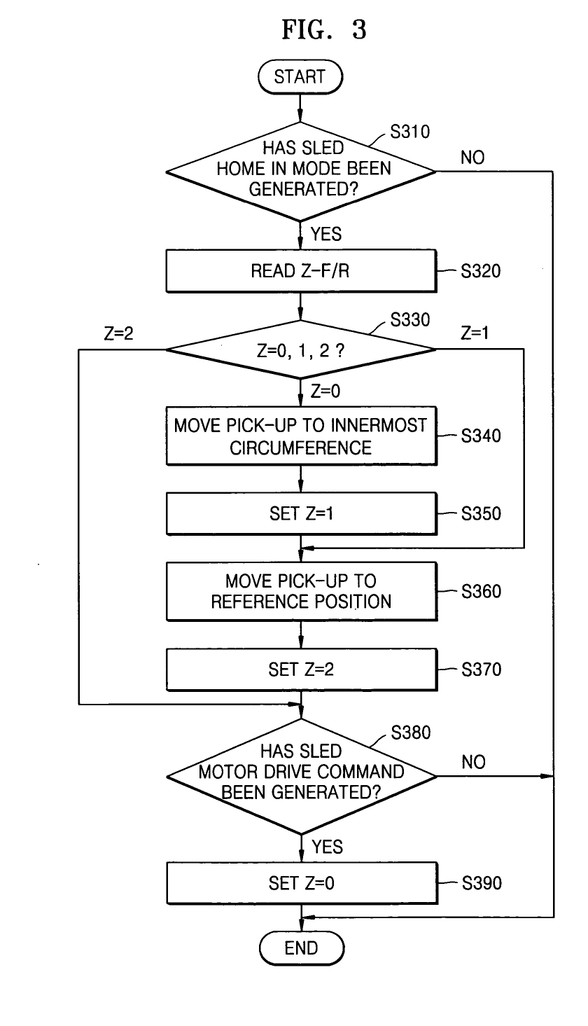

A method of adaptively controlling a sled home-in mode according to the invention is described below with reference to FIG. 3, in combination with the schematic diagram of the disc drive shown in FIG. 2.

A system controller 70 determines whether a disc drive has entered a system initialize mode. In other words, in operation 310, the system controller 70 determines whether a sled home-in command has been generated in the system initialize mode. The system initialize mode includes conditions for performing the power on/off mode, the tray open/close mode, etc.

When the sled home-in command is determined to have been generated, system controller 70 reads the flag information Z from a flag register 70-1 in the system controller 70 in operation 320.

The system controller 70 determines where a pick-up 20 is positioned according to the flag information Z read from the flag register, in operation 330.

When the flag information Z is 0, which indicates that the pick-up 20 is positioned neither on an innermost circumference, nor in a reference position of the disc, the system controller 70 drives a sled motor 110 to move the pick-up 20 to the innermost circumference of the disc 10 in operation 340. The system controller 70 changes the flag information into a 1 and stores it in the flag register 70-1 in operation 350.

After completing the operation 350, or when the flag information Z is 1, indicating that the pick-up 20 is positioned on the innermost circumference of the disc 10 in operation 330, the system controller 70 drives the sled motor 110 to move the pick-up 20 to the reference position of the disc in operation 360. The system controller 70 changes the flag information into a 2 and stores it in the flag register 70-1 in operation 370.

After completing the operation 370, or when the flag information Z is 2, it is determined that the sled home-in mode is completed.

After the sled home-in mode is completed, the system controller 70 determines whether a sled motor drive command to move the pick-up 20 to a target track of the disc has been generated in operation 380. When the sled motor drive command has been generated and the pick-up 20 was moved, the system controller 70 changes the flag information into 0 and stores it in the flag register 70-1 in operation 390.

According to the method of controlling a sled home-in mode, as described above, even when the sled home-in command is repeatedly generated during the system initialize mode, the disc drive is able to detect the position of the pick-up 20 using the flag information Z, and perform the sled home-in mode very fast.

According to the invention, the position of the pick-up can be detected by using the flag information before performing the sled home-in mode, and therefore conditions to perform the sled home-in mode are more suitably set, and the time of performing the sled home-in mode is shortened. For example, when the tray open/close mode is repeatedly performed when the pick-up is not moved, the sled home-in mode is performed much faster.

The invention can be realized as a method, an apparatus or a system. When the invention is realized as a computer software program, it is well understood that components of the invention may be replaced with code segments that are necessary to perform the required action. Programs or code segments may be stored in media readable by a computer processor, and transmitted as computer data that is combined with carrier waves via a transmission media or a communication network. The media readable by a processor include anything that can store and transmit information, such as electronic circuits, semiconductor memory devices, ROM, flash memory, EEPROM, floppy discs, optical discs, hard discs, optical fiber, radio frequency (RF) networks, etc. The computer data also includes any data that can be transmitted via an electric network channel, optical fiber, air, electromagnetic field, RF network, etc.

Although a few embodiments of the invention have been shown and described, it would be appreciated by those skilled in the art that changes may be made in these embodiments without departing from the principles and spirit of the invention, the scope of which is defined in the claims and their equivalents.

1. A method of adaptively controlling a sled home-in mode in a disc drive, the method comprising:
determining whether the disc drive is in a system initialize mode;
reading flag information that indicates a position of a pick-up over a disc when the disc drive is determined to be in the system initialize mode; and
moving the pick-up from the position corresponding to the flag information to a reference position.

2. The method of adaptively controlling the sled home-in mode as claimed in claim 1, wherein the system initialize mode includes a function to perform a tray open/close mode.

3. The method of adaptively controlling the sled home-in mode as claimed in claim 1, further comprising:
setting the flag information according to a position of the pick-up,
wherein a first state information is set when the pick-up is positioned at an innermost circumference of the disc, a second state information is set when the pick-up is positioned at the reference position of the disc after the completion of the sled home-in mode, and a third state information is set when the pick-up is positioned neither on the innermost circumference nor in the reference position of the disc.

4. The method of adaptively controlling the sled home-in mode as claimed in claim 1, wherein the moving the pick-up to a reference position on the disc comprises:
driving a sled motor toward an outer circumference of the disc to move the pick-up to the reference position when the flag information indicates that the pick-up is positioned on an innermost circumference of the disc
stopping the sled home-in mode when the flag information indicates that the pick-up is positioned at the reference position of the disc; and
driving the sled motor toward the inner circumference of the disc to move the pick-up to the innermost circumference of the disc and then driving the sled motor toward the outer circumference of the disc to move the pick-up to the reference position when the flag information indicates that the pick-up is positioned neither on the innermost circumference nor at the reference position of the disc.

5. A disc drive system for adaptively controlling a sled home-in mode, comprising:
a pick-up that includes a laser diode, a plurality of photo diodes, and a plurality of types of lenses, the pick-up records signals on a disc and/or detects optical signals reflected from the disc, and converts the optical signals into electrical signals;
a sled motor that moves the pick-up in a horizontal direction of the disc;
a system controller that sets information in a flag register, according to a position of the pick-up in relation to the disc, reads the information in the flag register when the disc drive is in a system initialize mode, and generates sled motor control signals to move the pick-up from a position that corresponds to the information in the flag register to a reference position of the disc;
a servo controller that generates sled motor driving voltages that correspond to the sled motor control signals; and
a driving unit that generates driving currents to drive the sled motor, the driving currents corresponding to the sled motor driving voltages.

6. The disc drive system as claimed in claim 5, wherein the system initialize mode includes a function to perform a tray open/close mode.

7. The disc drive system as claimed in claim 5, wherein the information in the flag register is a first state information when the pick-up is positioned on the innermost circumference of the disc, the information in the flag register is a second state information when the pick-up is positioned at a reference position of the disc after the completion of the sled home-in mode, and the information in the flag register is a third state information, when the pick-up is positioned neither on the innermost circumference nor in the reference position of the disc.

8. The disc drive system of claim 5, wherein the system controller:
drives the sled motor toward the outer circumference of the disc to move the pick-up to the reference position of the disc when the information in the flag register indicates that the pick-up is positioned on the innermost circumference of the disc;
stops the sled home-in mode when the information in the flag register indicates that the pick-up is positioned at the reference position of the disc; and
drives the sled motor toward the inner circumference of the disc to move the pick-up to the innermost circumference of the disc and then drives the sled motor toward the outer circumference of the disc to move the pick-up to the reference position of the disc, when the information indicates that the pick-up is positioned neither on the innermost circumference nor at the reference position of the disc.

9. A method of adaptively controlling a sled home-in mode in a disc drive during a system initialize mode, the method comprising:
determining a current position of a pick-up unit in relation to a disc according to flag information that is set according to a plurality of predetermined areas on the disc, and
moving the pick-up unit from a current position to a reference position,
wherein the determining the current position of the pick-up unit according to the flag information is done before performing the sled home-in mode such that the sled-home in mode is stopped if the pick-up unit is determined to be at the reference position.

10. The method of adaptively controlling the sled home-in mode as claimed in claim 9, wherein the determining the current position of the pick-up unit according to the flag information further comprises:
setting a first flag position when the pick-up unit is positioned at a reference position of the disc after the completion of the sled home-in mode;
setting a second flag position when the pick-up unit is positioned at a predetermined area that is an innermost area of the disc inside of the reference position; and
setting a third flag position when the pick-up unit is positioned neither at the predetermined area of the disc nor at the reference position,
wherein the first, second, and third flag positions are stored in a flag register.

11. The method of adaptively controlling the sled home-in mode as claimed in claim 10, wherein the moving the pick-up unit to the reference position on the disc comprises:
moving the pick-up unit to the reference position when the flag information indicates that the pick-up unit is located in the predetermined area of the disc;
stopping the moving of the pick-up unit when the flag information indicates that the pick-up unit is located at the reference position; and
moving the pick-up unit to the innermost circumference of the disc and then moving the pick-up unit to the reference position when the flag information indicates that the pick-up unit is positioned neither on the predetermined area of the disc nor at the reference position.

12. The method of adaptively controlling the sled home-in mode as claimed in claim 11, further comprising:
driving a sled motor to move the pick-up unit to the predetermined area of the disc when the pick-up unit is positioned neither at the predetermined area of the disc nor in the reference position;
changing the flag information relating to the pick-up unit to the second flag position; and
storing the changed flag information in the flag register.

13. The method of adaptively controlling the sled home-in mode as claimed in claim 12, further comprising:
driving the sled motor to move the pick-up unit to the reference position when the pick-up unit is positioned at the predetermined area;
changing the flag information relating to the pick-up unit to the first flag position; and
storing the changed flag information in the flag register,
wherein after the storing the changed flag information in the flag register, it is determined that the sled home-in mode is completed.

14. The method of adaptively controlling the sled home-in mode as claimed in claim 9, further comprising:
determining whether a sled home-in command is generated in the system initialize mode; and
reading the flag information to determine the current position of the pick-up unit after determined that the sled home-in command is generated in the system initialize mode.

15. A disc drive system for adaptively controlling a sled home-in mode, comprising:
a pick-up unit to read and record information from a disc surface;
a sled motor to move the pick-up unit according to predetermined areas of the disc surface; and
a controller to set and store pick-up position information in a flag register, read the pick-up position information from the flag register when the disc drive system has entered a system initialize mode, and move the sled motor from a current position to a reference position of the disc surface according to the pick-up position information,
wherein the current position of the pick-up is detected using information in the flag register before the sled home-in mode is performed.

16. The disc drive system for adaptively controlling the sled home-in mode as claimed in claim 15, further comprising:
a servo controller to generate sled motor driving voltages corresponding to sled motor control signals; and
a driving unit to generate driving currents to drive the sled motor, the driving currents corresponding to the sled motor driving voltages.

17. The disc drive system for adaptively controlling the sled home-in mode as claimed in claim 15, wherein the pick-up position information stored by the controller in the flag register comprises:
a first flag position indicating when the pick-up unit is positioned at a reference position of the disc;
a second flag position indicating when the pick-up unit is positioned at a first predetermined area, which is an innermost area of the disc inside of the reference position; and
a third flag position indicating when the pick-up unit is positioned neither at the first predetermined area of the disc nor at the reference position.

18. The disc drive system for adaptively controlling the sled home-in mode as claimed in claim 15, wherein the controller:
drives the sled motor toward an outer circumference area of the disc to move the pick-up unit to the reference position of the disc when the pick-up position information indicates that the pick-up unit is positioned at the first predetermined area;
stops the sled home-in mode when the pick-up position information indicates that the pick-up unit is positioned at the reference position; and
drives the sled motor toward the inner circumference of the disc to move the pick-up unit to the first predetermined area and then drives the sled motor toward the outer circumference of the disc to move the pick-up unit to the reference position when the pick-up position information indicates that the pick-up unit is positioned neither at the first predetermined area nor at the reference position.

19. The disc drive system for adaptively controlling the sled home-in mode as claimed in claim 18, wherein when the pick-up unit is positioned neither at the predetermined area of the disc, nor in the reference position, the controller drives the sled motor in order to move the pick-up to the first predetermined area of the disc and the controller changes the flag information relating to the pick-up unit to the second flag position.

20. The disc drive system for adaptively controlling the sled home-in mode as claimed in claim 15, wherein the system initialize mode includes a function to perform a tray open/close mode.

21. A computer program to be read by a computer for adaptively controlling a sled home-in mode in a disc drive, comprising:
determining whether the disc drive is in a system initialize mode;
reading flag information that indicates a position of a pick-up over a disc when the disc drive is determined to be in the system initialize mode; and
moving the pick-up from the position corresponding to the flag information to a reference position.

22. The computer program for adaptively controlling the sled home-in mode in the disk drive as claimed in claim 21, further comprising:
driving a sled motor toward an outer circumference of the disc to move the pick-up to the reference position when the flag information indicates that the pick-up is positioned on an innermost circumference of the disc;
stopping the sled home-in mode when the flag information indicates that the pick-up is positioned at the reference position of the disc; and
driving the sled motor toward the inner circumference of the disc to move the pick-up to the innermost circumference of the disc and then driving the sled motor toward the outer circumference of the disc to move the pick-up to the reference position when the flag information indicates that the pick-up is positioned neither on the innermost circumference nor at the reference position of the disc.
